(19) United States
(12) Patent Application Publication
(10) Pub. No.: US 2025/0328594 A1
(43) Pub. Date: Oct. 23, 2025

(54) USING A MODEL OF AN ONLINE SYSTEM TO SELECT LAYOUT TEMPLATE FOR SEARCH RESULTS USER INTERFACE

(71) Applicant: Maplebear Inc., San Francisco, CA (US)

(72) Inventors: Vinesh Reddy Gudla, South San Francisco, CA (US); Laurentia Romaniuk, San Francisco, CA (US); Justin Park, Santa Barbara, CA (US); Victor Doss, San Ramon, CA (US); Mohammed Asif Ashique Hussain, Seattle, WA (US); Prathyusha Bhaskar Karnam, Sunnyvale, CA (US); Prakash Putta, Seattle, WA (US); Akshay Nair, San Francisco, CA (US); Nkemakonam Paulet Okoye, Bellevue, WA (US)

(21) Appl. No.: 18/643,900

(22) Filed: Apr. 23, 2024

(51) Int. Cl. G06F 16/9538

(52) U.S. Cl. CPC G06F 16/9538

(57) ABSTRACT

A trained model is used to select a layout template for a search results user interface displayed at a device associated with a user of the online system. Upon receiving a search query via a user interface of the device, the online system applies a search query model trained to identify, based on the search query and user data, a set of search results. Upon identifying the set of search results, the online system applies a layout selection model trained to identify, based at least in part on the set of search results, a layout for the search results user interface. The online system causes the device associated with the user to display the set of search results at the search results user interface using the identified layout for the search results user interface.

### BACKGROUND

Results of search queries made by users of online systems, such as online concierge systems, have traditionally been displayed in a grid or organized into carousels to group similar items together. This approach relies on ranking algorithms to identify and sort results of the search query in a manner that shows the most relevant content to users. However, the traditional grid-based display of search results can be overwhelming to users, especially for broad-intent search queries, where an amount of relevant content may be very large, thereby making it difficult for the users to find what they are actually looking for. Therefore, there is a technical problem of how to automatically and at a large scale organize results of a search query for display at a user interface of a user's client device in an explainable manner that helps the user to efficiently locate content for which they are looking.

### SUMMARY

Embodiments of the present disclosure are directed to using a model of an online system (e.g., online concierge system) to select a layout template for a search results user interface displayed at a device associated with a user of the online system.

In accordance with one or more aspects of the disclosure, the online system receives a search query via a user interface of a device associated with a user of the online system. The online system accesses a search query model of the online system, wherein the search query model is trained to identify a set of search results matching the search query. The online system applies the search query model to output, based on the search query and user data associated with the user, the set of search results. The online system accesses a layout selection model of the online system, wherein the layout selection model is trained to identify a layout for a search results user interface at the device associated with the user. The online system applies the layout selection model to identify, based at least in part on the set of search results, the layout for the search results user interface. The online system causes the device associated with the user to display the set of search results at the search results user interface using the identified layout for the search results user interface.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates examples of different layout templates for a search results user interface of a device associated with a user of an online concierge system, in accordance with one or more embodiments.

FIG. 4A illustrates an example search results user interface of a device associated with a user of an online concierge system populated with substitute content in response to a search query, in accordance with one or more embodiments.

FIG. 4B illustrates an example search results user interface of a device associated with a user of an online concierge system populated with primary content in response to a search query, in accordance with one or more embodiments.

FIG. 4C illustrates an example search results user interface of a device associated with a user of an online concierge system populated with complementary content in response to a search query, in accordance with one or more embodiments.

FIG. 4D illustrates an example search results user interface of a device associated with a user of an online concierge system populated with weaving content in response to a search query, in accordance with one or more embodiments.

FIG. 5 illustrates an example architectural flow diagram of using a trained model to select a layout template for a search results user interface of a device associated with a user of an online concierge system, in accordance with one or more embodiments.

FIG. 6 is a flowchart for a method of using a model of an online concierge system to select a layout template for a search results user interface of a device associated with a user of the online concierge system, in accordance with one or more embodiments.

### DETAILED DESCRIPTION

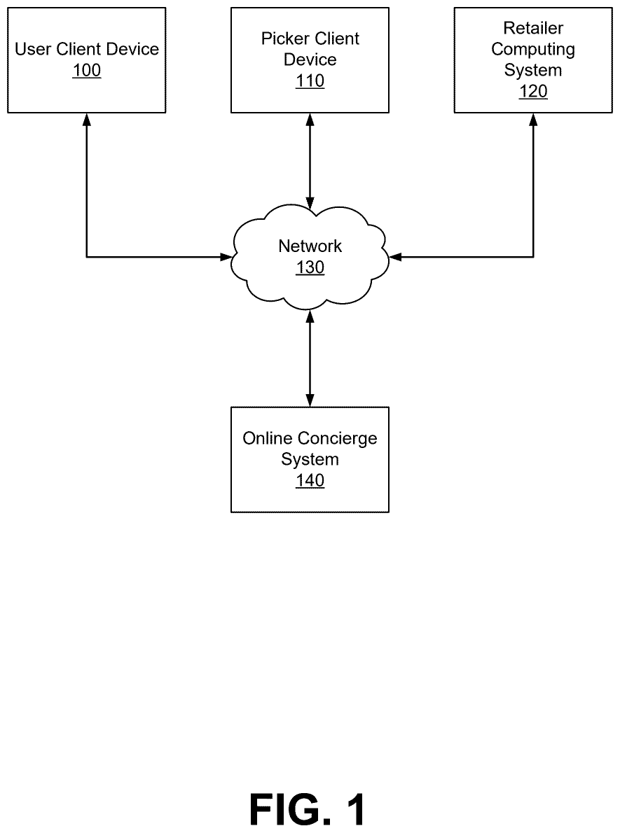

FIG. 1 illustrates an example system environment for an online concierge system 140, in accordance with one or more embodiments. The system environment illustrated in FIG. 1 includes a user client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and retailer computing system 120 are illustrated in FIG. 1, any number of users, pickers, and retailers may interact with the online concierge system 140. As such, there may be more than one user client device 100, picker client device 110, or retailer computing system 120.

The user client device 100 is a client device through which a user may interact with the picker client device 110, the retailer computing system 120, or the online concierge system 140. The user client device 100 can be a personal or mobile computing device, such as a smartphone, a tablet, a laptop computer, or desktop computer. In some embodiments, the user client device 100 executes a client application that uses an application programming interface (API) to communicate with the online concierge system 140.

A user uses the user client device 100 to place an order with the online concierge system 140. An order specifies a set of items to be delivered to the user. An “item,” as used herein, means a good or product that can be provided to the user through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user can use to place an order with the online concierge system 140. The ordering interface may be part of a client application operating on the user client device 100. The ordering interface allows the user to search for items that are available through the online concierge system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

The user client device 100 may receive additional content from the online concierge system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online concierge system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a user's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the user client device 100 for display to the user, so that the user can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a user from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The user client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which users can order items to be provided to them by a picker from a retailer. The online concierge system 140 receives orders from the user client device 100 through the network 130. The online concierge system 140 selects a picker to service the user's order and transmits the order to the picker client device 110 associated with the picker. The picker collects the ordered items from a retailer location and delivers the ordered items to the user. The online concierge system 140 may charge a user for the order and provide portions of the payment from the user to the picker and the retailer.

As an example, the online concierge system 140 may allow a user to order groceries from a grocery store retailer. The user's order may specify which groceries they want delivered from the grocery store and the quantities of each of the groceries. The user client device 100 transmits the user's order to the online concierge system 140 and the online concierge system 140 selects a picker to travel to the grocery store retailer location to collect the groceries ordered by the user. Once the picker has collected the groceries ordered by the user, the picker delivers the groceries to a location transmitted to the picker client device 110 by the online concierge system 140.

The online concierge system 140 provides a search interface for users to search for items in a database maintained by the online concierge system 140 (e.g., items available for purchase). To provide a more effective user interface based on the results of the search, the online concierge system 140 runs a search algorithm to find one or more items matching a user's search query. The online concierge system 140 then applies a model (e.g., heuristic model or trained machine-learning model) to select a layout template for a search results user interface at the user client device 100 based, at least in part, on the items matching the search query. The model may be a classification model that dynamically determines the optimal layout template for a given request, which is a function of user data, a search query entered by the user, a retailer associated with the search query, etc.

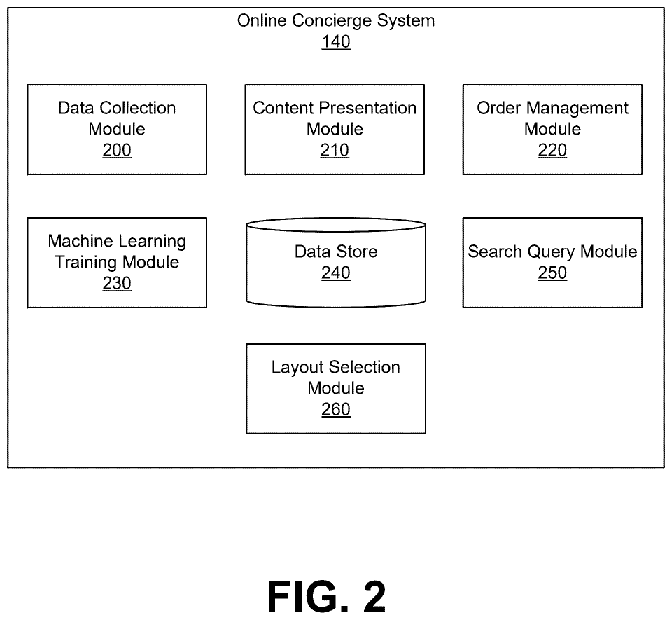

The online concierge system 140 presented herein organizes the search results in various layouts in an adaptive manner, based on an output of the model (e.g., machine-learning classifier model) that determines a layout template for the search results user interface that is customized based on context of the request. The layout template may include different slots for different types of item matches, such as primary matches (i.e., exact, or highly relevant items that match the search query), substitutes, complementary items, etc. and functional elements, such as filters for refining the search. The online concierge system 140 then generates a search results user interface at the user client device 100 with the items according to the selected layout template for presentation of the search results to the user. The online concierge system 140 is described in further detail below with regards to FIG. 2.

FIG. 2 illustrates an example system architecture for the online concierge system 140, in accordance with some embodiments. The system architecture illustrated in FIG. 2 includes a data collection module 200, a content presentation module 210, an order management module 220, a machine-learning training module 230, a data store 240, a search query module 250, and a layout selection module 260. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects user data, which is information or data that describe characteristics of a user. For example, the data collection module 200 may collect the user data that include a user's name, address, shopping preferences, favorite items, or stored payment instruments. The data collection module 200 may collect the user data that also include default settings established by the user, such as a default retailer/retailer location, payment instrument, delivery location, or delivery timeframe. The data collection module 200 may collect the user data from sensors on the user client device 100 or based on the user's interactions with the online concierge system 140.

The data collection module 200 also collects item data, which is information or data that identifies and describes items that are available at a retailer location. The data collection module 200 may collect the item data that include item identifiers for items that are available and may include quantities of items associated with each item identifier. Additionally, the data collection module 200 may collect the item data that also include attributes of items such as the size, color, weight, stock keeping unit (SKU), or serial number for the item. The data collection module 200 may collect the item data that further include purchasing rules associated with each item, if they exist. For example, age-restricted items such as alcohol and tobacco are flagged accordingly in the item data. The data collection module 200 may collect the item data that also include information that is useful for predicting the availability of items in retailer locations. For example, the data collection module 200 may collect the item data that include, for each item-retailer combination (a particular item at a particular warehouse), a time that the item was last found, a time that the item was last not found (a picker looked for the item but could not find it), the rate at which the item is found, or the popularity of the item. The data collection module 200 may collect the item data from the retailer computing system 120, the picker client device 110, or the user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the data collection module 200 may collect the picker data for a picker that include the picker's name, the picker's location, how often the picker has serviced orders for the online concierge system 140, a user rating for the picker, which retailers the picker has collected items at, or the picker's previous shopping history. Additionally, the data collection module 200 may collect the picker data that include preferences expressed by the picker, such as their preferred retailers to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects the picker data from sensors of the picker client device 110 or from the picker's interactions with the online concierge system 140.

Additionally, the data collection module 200 collects order data, which is information or data that describes characteristics of an order. For example, the data collection module 200 may collect the order data that include item data for items that are included in the order, a delivery location for the order, a user associated with the order, a retailer location from which the user wants the ordered items collected, or a timeframe within which the user wants the order delivered. Also, the data collection module 200 may collect the order data that further include information describing how the order was serviced, such as which picker serviced the order, when the order was delivered, or a rating that the user gave the delivery of the order. In some embodiments, the data collection module 200 collects the order data that include user data for users associated with the order, such as user data for a user who placed the order or picker data for a picker who serviced the order.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from the user client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to assign an order to a picker based on a delivery timeframe requested by the user with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use the user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may re-train the machine-learning model based on the actual performance of the model after the online concierge system 140 has deployed the model to provide service to users. For example, if the machine-learning model is used to predict a likelihood of an outcome of an event, the online concierge system 140 may log the prediction and an observation of the actual outcome of the event. Alternatively, if the machine-learning model is used to classify an object, the online concierge system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online concierge system 140 as a whole in its performance of the tasks described herein.

The data store 240 stores data used by the online concierge system 140. For example, the data store 240 stores user data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The search query module 250 may receive, from the user client device 100 via the network 130, a search query entered by a user of the online concierge system 140 via a search interface of the user client device 100. The search query may be a text that the user enters at the search interface when looking for one or more items (e.g., packaged brand items, produce items, etc.) for purchase via the online concierge system 140. Some examples of the search query can be “rockfish,” “ice cream,” “pomegranates,” “fruit,” etc. The search query module 250 may access a search query model (e.g., machine-learning model) that is trained to identify a set of search results matching the search query. The search query module 250 may deploy the search query model to run a machine-learning algorithm to output, based on the search query and user data, the set of search results. A set of parameters for the search query model may be stored at one or more non-transitory computer-readable media of the search query module 250. Alternatively, the set of parameters for the search query model may be stored at one or more non-transitory computer-readable media of the data store 240.

In providing the user data to the search query model, the search query module 250 may provide information about a purchase history of the user, a tenure of the user with the online concierge system 140, a user's spend budget for a defined time period (e.g., week, month, etc.), information of a current shopping cart of the user, some other information related to the user, or some combination thereof. The search query module 250 may retrieve the user data from a database of the online concierge system 140 (e.g., stored at the data store 240). Alternatively or additionally, the search query module 250 may receive the user data from the user client device 100 via the network 130.

In identifying the set of search results in response to the search query, the search query model may determine a relevance and ranking of each item that belongs to the set of search results. Hence, the search query model may determine which items belong in a particular section of the search results, such as a section of primary matches, section of substitute items, and section of complementary items. Additionally, the search query model may determine an order in which items are shown in any section of the search results. The set of search results identified by the search query model may be provided to another model for selecting a most appropriate layout for displaying the set of search results at a search results user interface of the user client device 100.

The layout selection module 260 may select, from a predetermined set of layouts, a most appropriate layout for displaying the set of search results at a search results user interface of the user client device 100. The layout selection module 260 may access a layout selection model (e.g., machine-learning model) that is trained to identify a layout for a search results user interface of the user client device 100. The layout selection module 260 may deploy the layout selection model to run a machine-learning algorithm to identify, based on a set of inputs, the layout for the search results user interface of the user client device 100. A set of parameters for the layout selection model may be stored at one or more non-transitory computer-readable media of the layout selection module 260. Alternatively, the set of parameters for the layout selection model may be stored at one or more non-transitory computer-readable media of the data store 240.

The layout selection module 260 may provide the set of inputs representing various input features to the layout selection model. In providing the set of inputs to the layout selection model, the layout selection module 260 may provide metadata of the search results, context data related to the search query, user's engagement data (e.g., conversions) for different layouts of the search results user interface, metadata of different layouts of the search results user interface, one or more features of the user (e.g., user's purchase history, user's tenure with the online concierge system 140, etc.), one or more features of a retailer associated with the online concierge system 140 that sells items of the search results, one or more features of the search query (e.g., intent of the search query, type of the search query, etc.), some other contextual information, or some combination thereof. The layout selection module 260 may retrieve the set of inputs from the data store 240, receive the set of inputs from the user client device 100 via the network 130, and/or receive the set of inputs from the retailer computing system 120 via the network 130. Based on the set of inputs, the layout selection model may output a label corresponding to a preferred layout for the search results user interface of the user client device 100 that is chosen for a given search query and corresponding search results identified by the search query model.

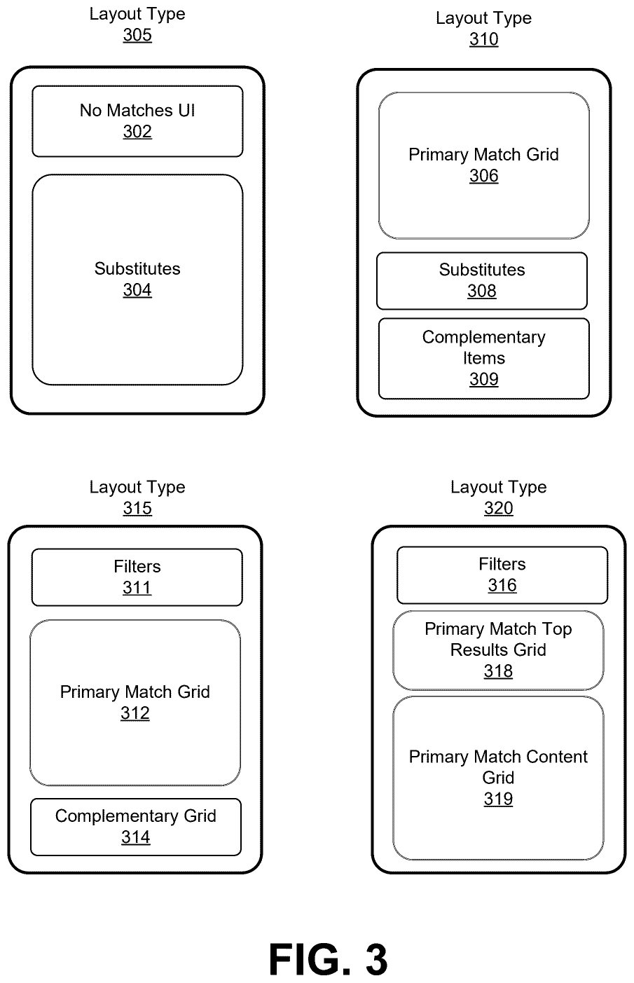

In one or more embodiments, the layout selection model is implemented as a heuristic model that selects a layout for a search results user interface of the user client device 100 based on a number of primary matches in search results identified by the search query model. For example, the heuristic-based layout selection model may select a first layout for the search results user interface of the user client device 100 when there are no primary matches in the search results. The heuristic-based layout selection model may select a second layout for the search results user interface of the user client device 100 when the number of primary matches in the search results is equal to or greater than a first threshold (e.g., one primary match) and less than or equal to a second threshold (e.g., 10 primary matches). Similarly, the heuristic-based layout selection model may select a third layout for the search results user interface of the user client device 100 when the number of primary matches in the search results is greater than the second threshold and less than or equal to a third threshold (e.g., 30 primary matches). And the heuristic-based layout selection model may select a fourth layout for the search results user interface of the user client device 100 when the number of primary matches in the search results is greater than the third threshold. The selected layout for the search results user interface of the user client device 100 may be then used to show the search results to the user. Different layouts for the search results user interface of the user client device 100 that can be selected by the heuristic-based layout selection model are described in further detail below with regards to FIG. 3.

The layout selection module 260 may initially determine a set of thresholds for the heuristic-based layout selection model (e.g., the first, second and third thresholds) using insights on how different users would engage with search results displayed using different layouts for the search results user interface of the user client device 100. The layout selection module 260 may further refine (or, more generally, update) the predetermined set of thresholds for the heuristic-based layout selection model empirically based on observed conversion rates, and exploration of conversion rates by varying the set of thresholds.

In one or more embodiments, the layout selection model is implemented as a machine-learning model that runs a machine-learning algorithm to a set of inputs to select a layout for the search results user interface of the user client device 100 that is used to display search results identified by the search query model. The layout selection model may be a nonlinear multitask machine-learning model that is trained to predict, for each layout type for the search results user interface, a likelihood of conversion by the user. In particular, the layout selection model may be a tree-based machine-learning model, such as the lightGBM (light gradient-boosting machine) classifier or the softmax classifier. The layout selection module 260 (or the content presentation module 210) may then select the layout for the search results user interface of the user client device 100 as the one with the highest predicted likelihood of user's conversion.

The layout selection module 260 may provide the set of inputs representing various input features to the machine-learning layout selection model. In providing the set of inputs to the machine-learning layout selection model, the layout selection module 260 may provide request context data and/or result metadata to the machine-learning layout selection model. The request context data may include a set of features for the user, platform features, a set of features of the search query, a set of features of a retailer that sells items identified as part of the search results, some other contextual features, or some combination thereof. The set of user's features may include general user features, such as a tenure of the user with the online concierge system 140, a history of orders placed by the user, a gross merchandise value (GMV) associated with the user, etc. The layout selection module 260 may retrieve the set of user's features from the data store 240. The set of features of the search query may include information about a user's intent in relation to the search query (e.g., exploratory, restocking, etc.), a specificity of the search query, a category classification (e.g., type) of the search query, etc. The result metadata may include information about a density of highly relevant content (e.g., primary matches) within the search results, information about a density of complementary content (e.g., complementary items) within the search results, information about a density of advertising content within the search results, some other density information in relation to the search results, or some combination thereof.

The machine-learning layout selection model may identify a preferred layout to apply for a particular set of search results based on the request context data and/or the result metadata. The machine-learning layout selection model implemented as a classification model may output, based on the set of input features, a label that identifies the preferred layout for displaying the particular set of search results. In one or more embodiments, the machine-learning layout selection model predicts a logit of user's conversion for each layout of a predetermined set of layouts for the search results user interface of the user client device 100. The machine-learning layout selection model may then output a label of the layout that has a highest logit among the predetermined set of layouts. The layout with the highest logit may then be used to display the search results at the search results user interface of the user client device 100. The predetermined set of layouts may be a set of different layouts (e.g., four layout templates) that vary the number of exact matches, substitute results and/or complementary results. The predetermined set of layouts from which a preferred layout is predicted by the machine-learning layout selection model are described in further detail below with regards to FIG. 3.

The content presentation module 210 may receive from the layout selection module 260 (or directly from the layout selection model), a label that identifies a preferred layout for a search results user interface of the user client device 100 as selected by the layout selection model. Using the received label, the content presentation module 210 may retrieve a corresponding layout template from a collection of layout templates that can be stored at, e.g., the data store 240. The content presentation module 210 may then cause the user client device 100 to display a search results user interface with search results (e.g., as identified by the search query model) using the retrieved layout template.

The machine-learning training module 230 may perform initial training of the layout selection model using training data. The machine-learning training module 230 may generate the training data by impressing different layouts for search results user interfaces of user client devices 100 to a collection of users of the online concierge system 140 via randomized trials and measuring engagement data by the collection of users when different search results are displayed using the randomly assigned layouts. The measured engagement data may include information about an initial likelihood of conversion for each layout type and/or information about an initial likelihood of viewing the search results without conversion for each layout type. The machine-learning training module 230 may train the layout selection model using the training data to generate initial values for the set of parameters of the layout selection model. Hence, the initial exploration used for obtaining the training data may provide the prior conversion probability for each layout type. The machine-learning training module 230 may further collect additional user engagement data upon different layout types are identified by the layout selection model and used for displaying different sets of search results to users of the online concierge system 140. The machine-learning training module 230 may then re-train the layout selection model by updating the set of parameters of the layout selection model using the collected additional user engagement data. Furthermore, the machine-learning training module 230 may re-train the search query model by updating, using the collected additional user engagement data, the set of parameters of the search query model.

The online concierge system 140 presented herein organizes search results in a dynamic manner that aids explainability of the search results to a user of the online concierge system 140 and helps improve efficiency in finding the exact items. As aforementioned, different layouts for a search results user interface of the user client device 100 can be selected to organize the search results based on various factors, such as a density of relevant results, density of ads, type of search query, one or more features of a corresponding retailer, etc.

FIG. 3 illustrates examples of different layouts for a search results user interface of the user client device 100, in accordance with one or more embodiments. Each layout type in FIG. 3 is differentiated from other layout types based on how many relevant matches are identified for a given search query. The layout selection model may select a layout type 305 when there are no relevant matches in search results identified by the search query model in response to a search query. The layout type 305 may be designed to be upfront about primary matches being out-of-stock or not carried, e.g., via “No Matches UI” 302. The layout type 305 may be further designed to suggest alternatives to missing primary matches (e.g., via substitutes 304) so there is no dead end to the search query.

The layout selection model may select a layout type 310 when there are few relevant matches (e.g., 1 to 10 primary matches) in search results identified by the search query model in response to a search query. The layout type 310 may be designed to ensure that primary matches are front and center, e.g., via a primary match grid 306. The layout type 310 may further offer popular alternatives (e.g., via substitutes 308) and inspire users with complementary items 309.

The layout selection model may select a layout type 315 when there are “plenty” of relevant matches (e.g., 11 to 30 primary matches) in search results identified by the search query model in response to a search query. The layout type 315 may be designed to help users evaluate the selection and home-in on what they need. The layout type 315 may include filters 311 positioned on top that allow for refining of the initial search query. The filters 311 may use common search refinements for the initial search query, use historical search results to refine the initial search query, use a model (e.g., large language model) to suggest refinements of the initial search query, etc. At the center, the layout type 315 may include a primary match grid 312 with primary matches (i.e., relevant items). The bottom of the layout type 315 may include a complementary grid 314 to serve up complementary inspiration to users.

The layout selection model may select a layout type 320 when there are “too many” of relevant matches (e.g., more than 30 primary matches) in search results identified by the search query model in response to a search query. The layout type 320 may be designed to give users a “birds-eye view” of what is available and help them browse the selection with ease. The layout type 320 may include filters 316 positioned on top that allow for refining of the initial search query. The filters 316 may use common search refinements for the initial search query, use historical search results to refine the initial search query, use a model (e.g., large language model) to suggest refinements of the initial search query, etc. Below the filters 316, the layout type 320 may include a primary match top results grid 318 with the most relevant items. The most relevant items within the primary match top results grid 318 may be determined and ranked by the search query model. Below the primary match top results grid 318, the layout type 320 may include a primary match content grid 319. For example, the search query model may determine what relevant items are grouped into the primary match content grid 319 instead of being grouped into the primary match top results grid 318. Note that within each type of content (primary, substitutes, and complementary), the search query model may organize search results into carousels by grouping rules, and then apply ranking within carousels to rank items.

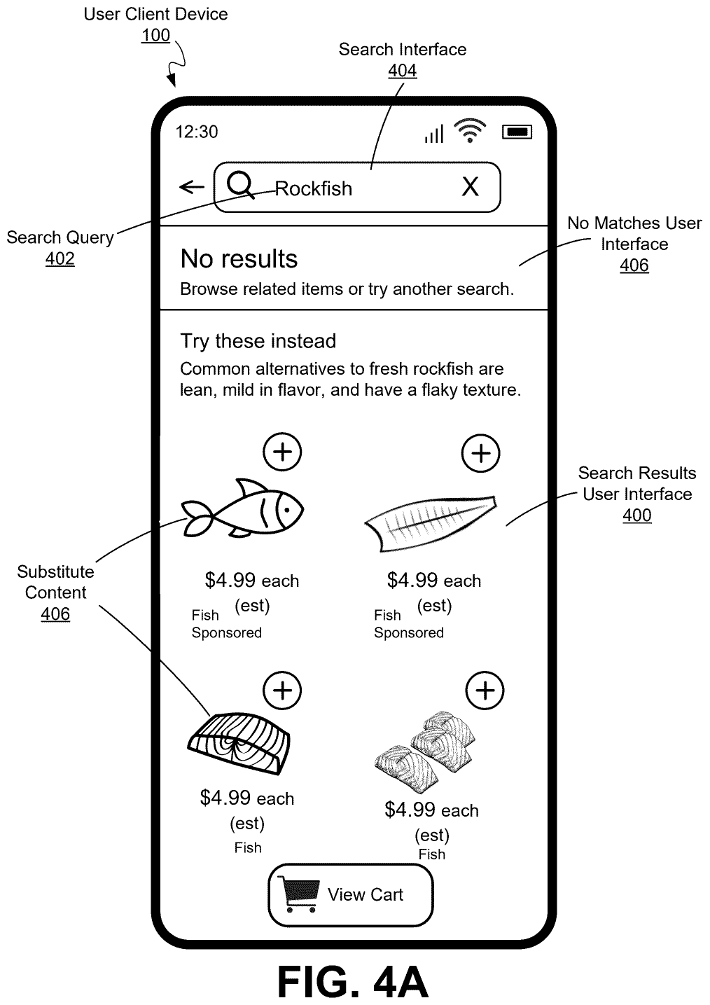

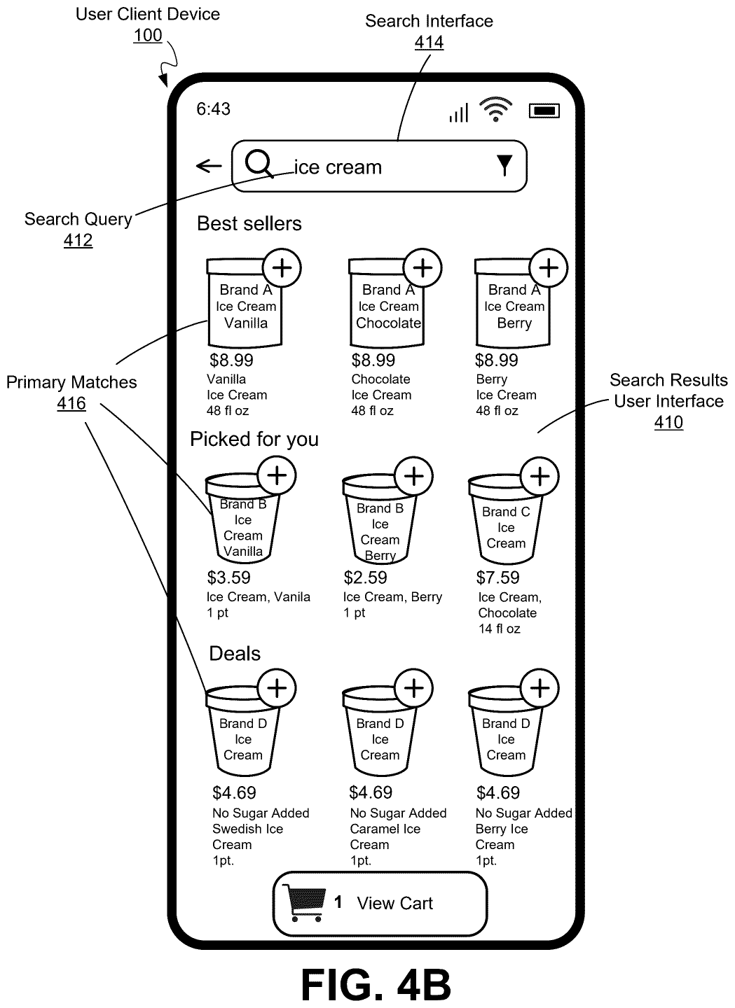

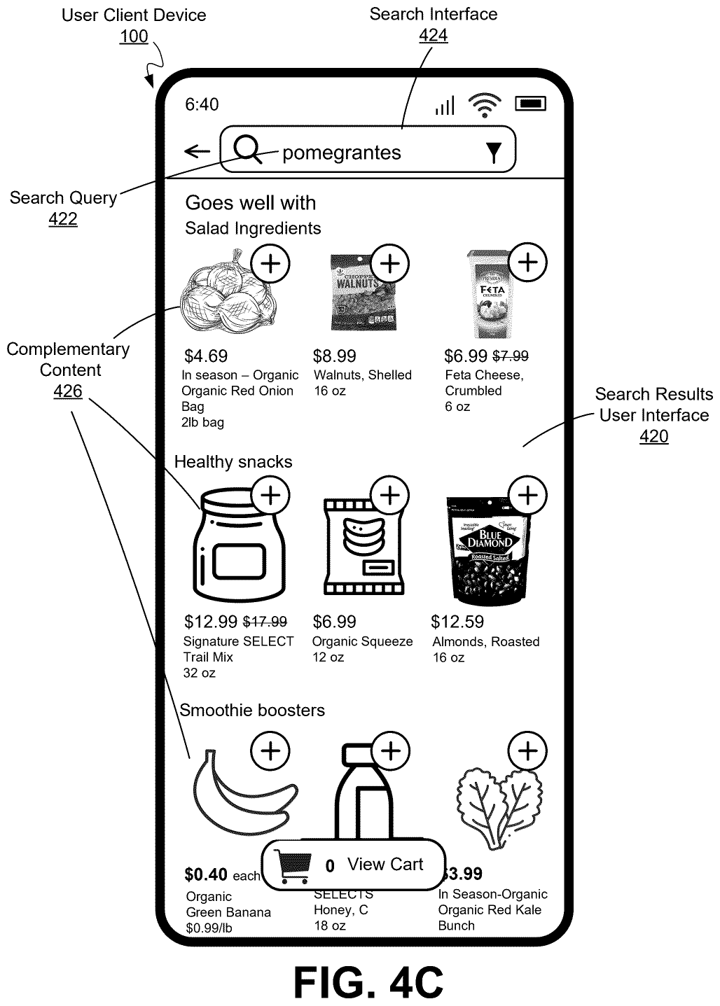

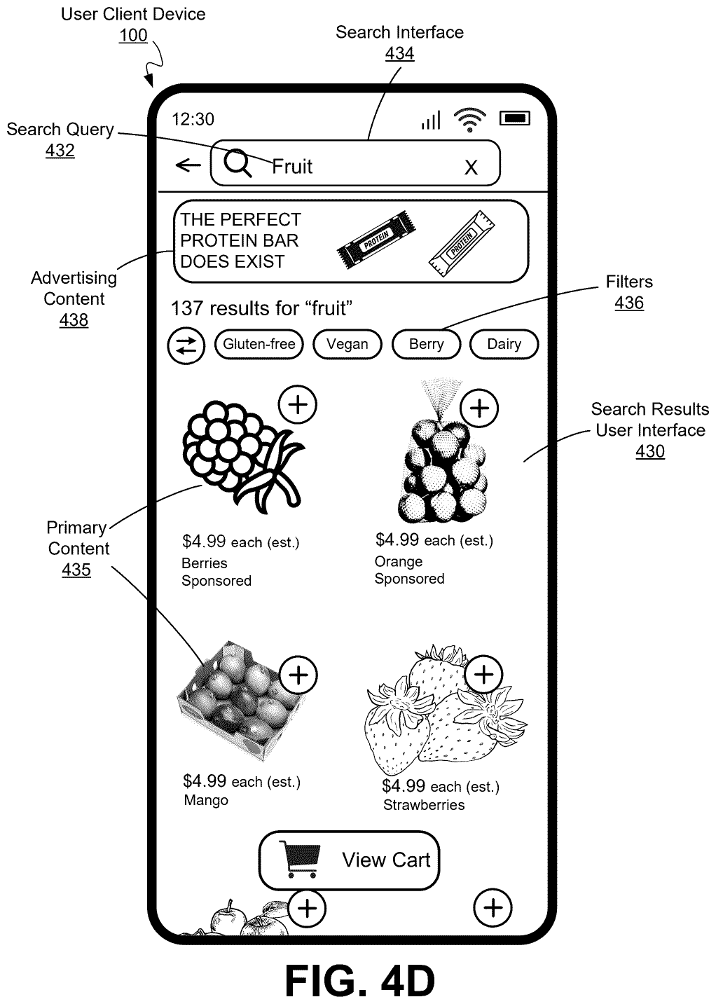

FIG. 4A illustrates an example search results user interface 400 of the user client device 100 populated with substitute content in response to a search query 402, in accordance with one or more embodiments. The content presentation module 210 may cause the user client device 100 to display the search results user interface 400 during a user's ordering session or before a start of the user's ordering session. The search query 402 (e.g., “Rockfish”) is entered by a user of the online concierge system 140 via a search interface 404. The search results user interface 400 is displayed using the layout type 305 as no primary matches to the search query 402 are identified by the search query model. The search results user interface 400 includes a no matches user interface 406 and substitute content 408.

FIG. 4B illustrates an example search results user interface 410 of the user client device 100 populated with primary content in response to a search query 412, in accordance with one or more embodiments. The content presentation module 210 may cause the user client device 100 to display the search results user interface 410 during a user's ordering session or before a start of the user's ordering session. The search query 412 (e.g., “ice cream”) is entered by a user of the online concierge system 140 via a search interface 414. The search results user interface 410 may be preferred when the number of primary marches 416 to choose from is greater than a threshold value (e.g., when there are “too many” primary matches). The search results user interface 410 uses the layout type 320 with the primary match top results grid 318 (e.g., “Best sellers” grid) and the primary match content grid 319 (e.g., “Picked for you” grid, and “Deals” grid).

FIG. 4C illustrates an example search results user interface 420 of the user client device 100 populated with complementary content in response to a search query 422, in accordance with one or more embodiments. The content presentation module 210 may cause the user client device 100 to display the search results user interface 420 during a user's ordering session or before a start of the user's ordering session. The search query 422 (e.g., “pomegranates”) is entered by a user of the online concierge system 140 via a search interface 424. The search results user interface 420 may be preferred when a primary intent of the search query is easily accomplished (e.g., few and plenty primary matches). The search results user interface 420 uses the layout type 310 to offer various complementary content 426 to users.

FIG. 4D illustrates an example search results user interface 430 of the user client device 100 populated with weaving content in response to a search query 432, in accordance with one or more embodiments. The content presentation module 210 may cause the user client device 100 to display the search results user interface 430 during a user's ordering session or before a start of the user's ordering session. The search query 432 (e.g., “fruit”) is entered by a user of the online concierge system 140 via a search interface 434. The search results user interface 430 may be preferred when a number of primary matches is greater than a predetermined threshold (e.g., when there are “too many primary matches”). Hence, the search results user interface 430 uses the layout type 320 of FIG. 3 with weaving content that organizes primary content 435 (i.e., relevant results) into carousels, thereby reducing the jumbled feeling of disparate items throughout the grid. However, the search results user interface 430 having the layout type 320 still maintains some ‘jumbling’ of items, which allows for mitigation against ads and search metric regressions on single items that are heavy-hitters and do not fit into a content concept. The search results user interface 430 includes filters 436 that offer navigation options for moving users towards desired results. The filters 436 can be designed to move users to relevant items in the search results user interface 430 and/or to sort out poor results. The search results user interface 430 may further include advertising content 438.

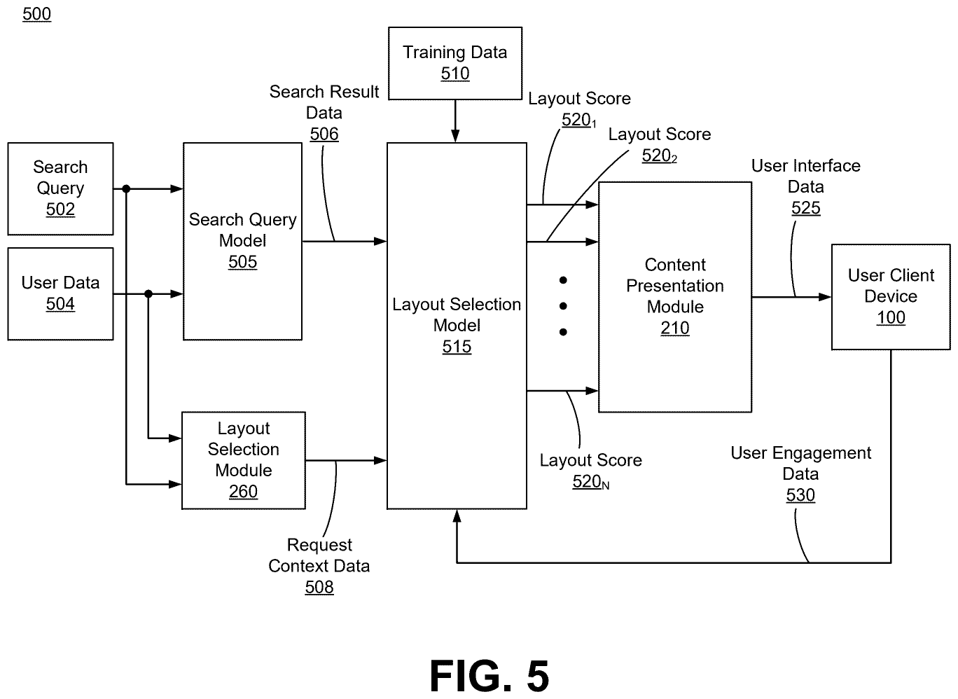

FIG. 5 illustrates an example architectural flow diagram 500 of using a layout selection model 515 to select a layout template for a search results user interface of the user client device 100, in accordance with one or more embodiments. First, the online concierge system 140 may apply (e.g., via the search query module 250) a search query model 505 (e.g., machine-learning model) to output search result data 506 based on a search query 502 and user data 504 input into the search query model 505. The search query 502 may be entered by a user via a search interface of the user client device 100 and received at the online concierge system 140 (e.g., at the search query module 250) from the user client device 100 via the network 130. In providing the user data 504 to the search query model 505, the online concierge system 140 (e.g., the search query module 250) may provide information about a purchase history of the user, a tenure of the user with the online concierge system 140, a user's spend budget for a defined time period (e.g., week, month, etc.), information of a current shopping cart of the user, some other information related to the user, or some combination thereof. The user data 504 may be retrieved from a database of the online concierge system 140 (e.g., stored at the data store 240). Alternatively or additionally, at least a portion of the user data 504 may be received from the user client device 100 via the network 130.

Based on the search query 502 and the user data 504, the search query model 505 may generate the search result data 506 with a set of items that matches the search query 502 given the known features of the specific user. The search query model 505 may rank each item within the search result data 506 based on their relevance to the search query 502 and/or the user data 504. Additionally, the search result data 506 may include metadata of search results, such as a density of primary matches (e.g., relevant items), a density of substitute content, a density of complementary content, etc. The search result data 506 may further include one or more features of a retailer associated with the online concierge system 140 that sells items identified as part of the search result data 506. The search result data 506 output by the search query model 505 may be provided as input features to the layout selection model 515.

Additionally, based on the search query 502 and the user data 504, the layout selection module 260 may generate request context data 508 for input into the layout selection model 515. In providing the request context data 508 to the layout selection model 515, the layout selection module 260 may provide context data related to the search query 502, information about engagement of the user for different layouts of a search results user interface, one or more features of the user (e.g., user's purchase history, user's tenure with the online concierge system 140, etc.), one or more features of the search query 502 (e.g., intent of the search query 502, type of the search query 502, etc.), some other contextual information, or some combination thereof.

The online concierge system 140 may perform (e.g., via the machine-learning training module 230) initial training of the layout selection model 515 using training data 510 to generate initial values for the set of parameters of the layout selection model 515. The training data 510 may be generated (e.g., via the machine-learning training module 230) by randomly assigning a layout for a search results user interface at the user client device 100 of each user in a collection of users for displaying search results and measuring conversion by that user of items in the search results displayed using the randomly assigned layout.

After the training process is completed, the layout selection model 515 may apply a machine-learning algorithm to the search result data 506 and the request context data 508 to output layout scores 520₁, 520₂, . . . , 520_{N} for all predefined layout types (e.g., the layout types 305, 310, 315 and 320 of FIG. 3). Each layout score 520₁, 520₂, . . . , 520_{N} may correspond to a predicted likelihood (or logit) of conversion by the user when the corresponding layout type is used to display search results at the search results user interface of the user client device 100. The layout scores 520₁, 520₂, . . . , 520_{N} output by the layout selection model 515 may be passed to the content presentation module 210.

The content presentation module 210 may identify a label of a layout type with the highest layout score among the layout scores 520₁, 520₂, . . . , 520_{N}. Based on the identified label of the layout type with the highest layout score, the content presentation module 210 may retrieve (e.g., from the data store 240) user interface data 525 that correspond to the layout type with the highest layout score. The content presentation module 210 may then utilize the user interface data 525 to cause the user client device 100 to display the search results as identified by the search query model 505 using the layout type with the highest layout score.

The user client device 100 may generate user engagement data 530 with information about the user's engagement in relation to the search results that were displayed at the user client device 100 using the layout type with the highest layout score for the user search results interface. The user engagement data 530 may include information about conversion by the user of one or more items of the displayed search results and/or information about views (e.g., clicks) made by the user in relation to items of the displayed search results. The user engagement data 530 may be recorded at the online concierge system 140 and utilized (e.g., via the machine-learning training module 230) to re-train the layout selection model 515. By utilizing the user engagement data 530, the machine-learning training module 230 may update the set of parameters of the layout selection model 515 in order to continuously improve the machine-learning algorithm of the layout selection model 515. Additionally, the machine-learning training module 230 may utilize the user engagement data 530 to re-train the search query model 505.

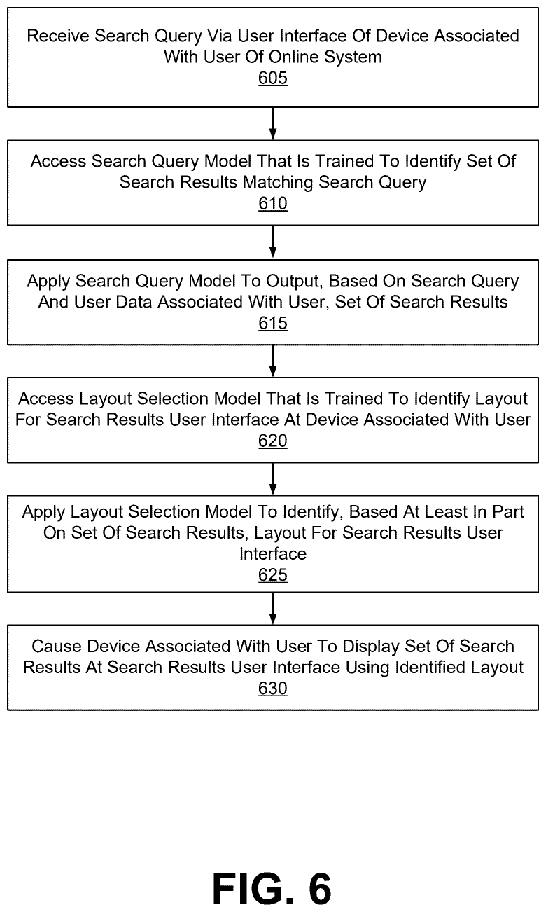

FIG. 6 is a flowchart for a method of using a model of an online concierge system to select a layout template for a search results user interface of a device associated with a user of the online concierge system, in accordance with one or more embodiments. Alternative embodiments may include more, fewer, or different steps from those illustrated in FIG. 6, and the steps may be performed in a different order from that illustrated in FIG. 6. These steps may be performed by an online concierge system (e.g., the online concierge system 140). Additionally, each of these steps may be performed automatically by the online concierge system without human intervention.

The online concierge system 140 receives 605 (e.g., via the search query module 250) a search query via a user interface of a device associated with a user of the online concierge system 140 (e.g., the user client device 100). The search query may be entered by the user via the user interface. The online concierge system 140 accesses 610 a search query model of the concierge system 140 (e.g., via the search query module 250), wherein the search query model is trained to identify a set of search results matching the search query. The online concierge system 140 applies 615 the search query model (e.g., via the search query module 250) to output, based on the search query and user data associated with the user, the set of search results. The online concierge system 140 may apply the search query model (e.g., via the search query module 250) to identify the set of search results including at least one of: a set of one or more primary matches, a set of one or more substitute items, a set of one or more complementary items, or a set of one or more functional blocks for filtering the set of search results. The set of primary matches may include one or more items that are the most relevant to the search query among the set of search results.

The online concierge system 140 accesses 620 a layout selection model of the online concierge system 140 (e.g., via the layout selection module 260), wherein the layout selection model is trained to identify a layout for a search results user interface at the device associated with the user. The online concierge system 140 applies 625 the layout selection model (e.g., via the layout selection module 260) to identify, based at least in part on the set of search results, the layout for the search results user interface.

The online concierge system 140 may apply the layout selection model (e.g., via the layout selection module 260) to identify, based on a number of the search results and a set of threshold values, the layout for the search results user interface. The online concierge system 140 may collect (e.g., via the machine-learning training module 230 or the layout selection module 260) feedback data with information about conversion by the user of the set of search results displayed at the search results user interface using the identified layout. The online concierge system 140 may update (e.g., via the machine-learning training module 230 or the layout selection module 260) the set of threshold values using the collected feedback data.

The online concierge system 140 may apply the layout selection model (e.g., via the layout selection module 260) to identify, based on context data associated with the search query and result metadata associated with the set of search results, a likelihood for conversion by the user for each layout of a plurality of layouts for the search results user interface. The online concierge system 140 may identify (e.g., via the layout selection module 260) the layout for the search results user interface that has a highest likelihood for conversion by the user among the plurality of layouts.

The online concierge system 140 may generate (e.g., via the layout selection module 260) the context data for the layout selection model by retrieving, from a database of the online concierge system 140 (e.g., at the data store 240), a set of features for the user and engagement data associated with the user for each layout of the plurality of layouts. Alternatively or additionally, the online concierge system 140 may generate (e.g., via the layout selection module 260) the context data for the layout selection model by extracting, from the search query, a set of one or more features of the search query including at least one of: an intent of the user, a specificity of the search query, or a classification category (e.g., type) of the search query.

Alternatively or additionally, the online concierge system 140 may generate (e.g., via the layout selection module 260) the context data for the layout selection model by retrieving, from the database, a set of features of a retailer associated with the online concierge system 140 that sells a set of items from the set of search results. Additionally, the online concierge system 140 may generate (e.g., via the layout selection module 260) the result metadata for the layout selection model by extracting, from the set of search results, at least one of: a density of primary matches in the set of search results, a density of complementary results in the set of search results, or a density of advertisements in the set of search results.

In one or more embodiments, the online concierge system 140 receives (e.g., via the search query module 250) a plurality of search queries entered by a collection of users of the online concierge system 140 via user interfaces of devices associated with the collection of users. The online concierge system 140 may apply the search query model (e.g., via the layout selection module 260) to output, based on the plurality of search queries and user data associated with the collection of users, a collection of sets of search results. The online concierge system 140 may randomly assign a layout from a plurality of layouts for a search results user interface at a respective device associated with a respective user of the collection of users for displaying a respective set of search results from the collection of sets of search results. The online concierge system 140 may generate (e.g., via the machine-learning training module 230) training data by measuring conversion by the respective user of the respective set of search results displayed using the randomly assigned layout. The online concierge system 140 may train (e.g., via the machine-learning training module 230) the layout selection model using the training data to generate a set of initial values for a set of parameters of the layout selection model.

The online concierge system 140 causes 630 (e.g., via the content presentation module 210) the device associated with the user to display the set of search results at the search results user interface using the identified layout for the search results user interface. The online concierge system 140 may collect (e.g., via the machine-learning training module 230) feedback data with information about conversion of the set of search results by the user, the set of search results being displayed at the search results user interface using the identified layout. The online concierge system 140 may re-train (e.g., via the machine-learning training module 230) the layout selection model by updating, using the collected feedback data, the set of parameters of the layout selection model.

Embodiments of the present disclosure are directed to the online concierge system 140 that organizes search results in an explainable manner to a user of the online concierge system 140 that helps to retrieve results in an efficient manner. The online concierge system 140 presented herein utilizes either heuristic approach or model-based approach to select a layout template for search results, which is dynamically based on the search results. The layout templates organize search results by type and have different types of search results (e.g., matches, substitutes, complementary results), as well as functional blocks or filters with options to refine the search results. Additionally, organization of the search results as presented herein opens the potential for merchandising opportunities within the search results without overwhelming the user with unrelated content.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

1. A method, performed at a computer system comprising a processor and a computer-readable medium, comprising:
receiving a search query via a user interface of a device associated with a user of an online system;
accessing a search query machine-learning model of the online system, wherein the search query machine-learning model is trained to identify a set of search results matching the search query;
applying the search query machine-learning model to the search query and user data associated with the user to generate the set of search results including a set of one or more primary matches representing one or more items that are the most relevant to the search query among the set of search results, a set of one or more complementary items for complementing the set of one or more primary matches, and a set of one or more functional blocks for filtering the set of search results;
generating result metadata by extracting, from the set of search results, a first density of the set of one or more primary matches in the set of search results and a second density of the set of one or more complementary items in the set of search results;
accessing a layout selection machine-learning model of the online system, wherein the layout selection machine-learning model is trained to identify a layout for a search results user interface at the device associated with the user;
applying the layout selection machine-learning model to the set of search results result metadata including information about the first density and information about the second density to identify the layout for the search results user interface; and
causing the device associated with the user to display the set of search results at the search results user interface using the identified layout for the search results user interface.

2. The method of claim 1, wherein applying the search query machine-learning model comprises:
identifying the set of search results further including a set of one or more substitute items for substituting the set of one or more primary matches.

3. The method of claim 1, wherein applying the layout selection machine-learning model comprises:
identifying, based on a number of search results in the set of search results and a set of threshold values, the layout for the search results user interface.

4. The method of claim 3, further comprising:
collecting feedback data with information about conversion by the user of the set of search results displayed at the search results user interface using the identified layout; and
updating the set of threshold values using the collected feedback data.

5. The method of claim 1, wherein applying the layout selection machine-learning model comprises:
identifying, based on context data associated with the search query and the result metadata, a likelihood for conversion by the user for each layout of a plurality of layouts for the search results user interface; and
identifying the layout for the search results user interface that has a highest likelihood for conversion by the user among the plurality of layouts.

6. The method of claim 5, further comprising:
generating the context data by retrieving, from a database of the online system, a set of features for the user and engagement data associated with the user for each layout of the plurality of layouts.

7. The method of claim 5, further comprising:
generating the context data by extracting, from the search query, a set of one or more features of the search query including at least one of an intent of the user, a specificity of the search query, or a classification category of the search query.

8. The method of claim 5, further comprising:
generating the context data by retrieving, from a database of the online system, a set of features of a retailer associated with the online system that sells a set of items from the set of search results.

9. The method of claim 1, wherein generating the result metadata further comprises:
extracting, from the set of search results, a third density of advertisements in the set of search results.

10. The method of claim 1, further comprising:
receiving a plurality of search queries entered by a collection of users of the online system via user interfaces of devices associated with the collection of users;
applying the search query machine-learning model to the plurality of search queries and user data associated with the collection of users to generate a collection of sets of search results;
randomly assigning a layout from a plurality of layouts for a search results user interface at a respective device associated with a respective user of the collection of users for displaying a respective set of search results from the collection of sets of search results;
generating training data by measuring conversion by the respective user of the respective set of search results displayed using the randomly assigned layout; and
training the layout selection machine-learning model using the training data to generate a set of initial values for a set of parameters of the layout selection machine-learning model.

11. The method of claim 10, further comprising:
collecting feedback data with information about conversion of the set of search results by the user, the set of search results being displayed at the search results user interface using the identified layout; and
re-training the layout selection machine-learning model by updating, using the collected feedback data, to update the set of parameters of the layout selection machine-learning model.

12. A computer program product comprising a non-transitory computer readable storage medium having instructions encoded thereon that, when executed by a processor, cause the processor to perform steps comprising:
receiving a search query via a user interface of a device associated with a user of an online system;
accessing a search query machine-learning model of the online system, wherein the search query machine-learning model is trained to identify a set of search results matching the search query;
applying the search query machine-learning model to the search query and user data associated with the user to generate the set of search results including a set of one or more primary matches representing one or more items that are the most relevant to the search query among the set of search results, a set of one or more complementary items for complementing the set of one or more primary matches, and a set of one or more functional blocks for filtering the set of search results;
generating result metadata by extracting, from the set of search results, a first density of the set of one or more primary matches in the set of search results and a second density of the set of one or more complementary items in the set of search results;
accessing a layout selection machine-learning model of the online system, wherein the layout selection machine-learning model is trained to identify a layout for a search results user interface at the device associated with the user;
applying the layout selection machine-learning model to the result metadata including information about the first density and information about the second density to identify the layout for the search results user interface; and
causing the device associated with the user to display the set of search results at the search results user interface using the identified layout for the search results user interface.

13. The computer program product of claim 12, wherein the instructions further cause the processor to perform steps comprising:
applying the layout selection machine-learning model to identify, based on a number of search results in the set of search results and a set of threshold values, the layout for the search results user interface;
collecting feedback data with information about conversion by the user of the set of search results displayed at the search results user interface using the identified layout; and
updating the set of threshold values using the collected feedback data.

14. The computer program product of claim 12, wherein the instructions further cause the processor to perform steps comprising:
applying the layout selection machine-learning model to identify, based on context data associated with the search query and the result metadata, a likelihood for conversion by the user for each layout of a plurality of layouts for the search results user interface; and
applying the layout selection machine-learning model to identify the layout for the search results user interface that has a highest likelihood for conversion by the user among the plurality of layouts.

15. The computer program product of claim 14, wherein the instructions further cause the processor to perform steps comprising:
generating the context data by retrieving, from a database of the online system, a set of features for the user and engagement data associated with the user for each layout of the plurality of layouts; and
generating the context data by further retrieving, from the database, a set of features of a retailer associated with the online system that sells a set of items from the set of search results.

16. The computer program product of claim 14, wherein the instructions further cause the processor to perform steps comprising:
generating the context data by extracting, from the search query, a set of one or more features of the search query including at least one of an intent of the user, a specificity of the search query, or a classification category of the search query.

17. The computer program product of claim 12, wherein the instructions further cause the processor to perform steps comprising:
generating the result metadata by further extracting, from the set of search results, a third density of advertisements in the set of search results.

18. The computer program product of claim 12, wherein the instructions further cause the processor to perform steps comprising:
receiving a plurality of search queries entered by a collection of users of the online system via user interfaces of devices associated with the collection of users;
applying the search query machine-learning model to output, based on the plurality of search queries and user data associated with the collection of users, a collection of sets of search results;
randomly assigning a layout from a plurality of layouts for a search results user interface at a respective device associated with a respective user of the collection of users for displaying a respective set of search results from the collection of sets of search results;
generating training data by measuring conversion by the respective user of the respective set of search results displayed using the randomly assigned layout; and
training the layout selection machine-learning model using the training data to generate a set of initial values for a set of parameters of the layout selection machine-learning model.

19. The computer program product of claim 18, wherein the instructions further cause the processor to perform steps comprising:
collecting feedback data with information about conversion of the set of search results by the user, the set of search results being displayed at the search results user interface using the identified layout; and
re-training the layout selection machine-learning model by updating, using the collected feedback data, to update the set of parameters of the layout selection machine-learning model.

20. A computer system comprising:
a processor; and
a non-transitory computer-readable storage medium having instructions that, when executed by the processor, cause the computer system to perform steps comprising:
receiving a search query via a user interface of a device associated with a user of an online system;
accessing a search query machine-learning model of the online system, wherein the search query machine-learning model is trained to identify a set of search results matching the search query;
applying the search query machine-learning model to the search query and user data associated with the user to generate the set of search results including a set of one or more primary matches representing one or more items that are the most relevant to the search query among the set of search results, a set of one or more complementary items for complementing the set of one or more primary matches, and a set of one or more functional blocks for filtering the set of search results;
generating result metadata by extracting, from the set of search results, a first density of the set of one or more primary matches in the set of search results and a second density of the set of one or more complementary items in the set of search results;
accessing a layout selection machine-learning model of the online system, wherein the layout selection machine-learning model is trained to identify a layout for a search results user interface at the device associated with the user;
applying the layout selection machine-learning model to the result metadata including information about the first density and information about the second density to identify the layout for the search results user interface; and
causing the device associated with the user to display the set of search results at the search results user interface using the identified layout for the search results user interface.
